(19) United States
(12) Patent Application Publication
(10) Pub. No.: US 2004/0190960 A1
(43) Pub. Date: Sep. 30, 2004

(54) Scanning system for copying documents or bound books

(76) Inventor: Chin-Piao Lin, Taipei (TW)

Correspondence Address: Richard P. Gilly, Wolf, Block, Schorr and Solis-Cohen LLP, 22nd Floor, 1650 Arch Street, Philadelphia, PA, 19103, US

(21) Appl. No.: 10/681,660

(22) Filed: Oct. 8, 2003

(30) Foreign Application Priority Data
Mar. 25, 2003 (TW) 092204570

(51) Int. Cl. G03G 15/00

(52) U.S. Cl. 399/362

(57) ABSTRACT

The scanning system for scanning a document placed on a document platen and for projecting an image onto a photosensitive image medium to form a latent image of the document thereon including a housing, a photosensitive scanner, and a scanning window is provided. Meanwhile, the photosensitive scanner is adapted to move beneath the platen in a scan operation for projecting the image onto the photosensitive image medium to form the latent image. The scanning window is mounted on a ceiling of the housing and a fringe of the scanning window bordered with a frame, wherein a top surface of the scanning window is substantially equal to that of the one side of the frame in height.

### FIELD OF THE INVENTION

The present invention relates to a scanning system, and more particularly to a scanning system for copying documents or bound books.

### BACKGROUND OF THE INVENTION

Conventionally, the key elements of the scan system are a photosensor, an illumination lamp such as a fluorescent lamp or an array of light emitting diodes, a set of lenses, a motor, and a power supply. The scanning operation of the prior art scan system is described as follows: The illumination lamp illuminates a flat document, or a bound document, such as a book. The image is reflected along an optical axis, projected through lens and reflected through mirror onto the surface of a photoreceptor drum or a charge-coupled device, CCD. The scanning operation is satisfactory for most applications, but is less than satisfactory for those systems which afford a book copying capability. Because of a binding edge of a book, the sensed light intensity of the binding edge is different.

Furthermore, the copying of non-planar originals, such as bound books, presents a problem because it is difficult to copy the information adjacent the binding of the book. The difficulties of reproduction in the binding area results from the portion of the book adjacent the binding being lifted away from the original image plane, which is usually defined by a planar transparent plate. The quality of the reproduction decreases in relation to increasing distance of the original image from the image plane. The lack of clarity and/or distortion in the copy results from several factors including 1) the projected image becomes increasingly out of focus as the original is scanned in the central binding area; 2) the illumination becomes less than optimal in the spine area; 3) there is compression of the image data along the scan length; and 4) there is degradation of the definition of the image data resulting from the original image being disposed at an angle to the image plane.

Nowadays, there are some inventions utilizing automatic electronic image correction technique to correct the book curve caused by the binding edge of a book. Although the book scanner system such as OMNISCAN 5000TT/5100TT is convenient and easy to digitize and/or copy books and bound documents and guarantees that the book bindings are not damaged, however, it is too expensive to use the instrument for the general public.

Another approach is to modify the platen to have a sloping edge portion so that the bound part of the book is placed in a corner position so that the entire surface of the page being copied is in intimate contact with the platen surface. An example of such a system is disclosed in U.S. Pat. No. 3,775,008. These systems have a disadvantage. The magnification range is limited because of restriction on scanner movement in the sloping corner edge.

In addition, the illumination lamp generally is a fluorescent lamp; however, the light intensity of the two ends of the fluorescent lamp is smaller than the central part thereof The prior art method and apparatus is to increase the length of the fluorescent lamp to increase the usable scan zone. Thus, the volume of the scan system must be increased.

It is therefore attempted by the applicant to deal with the above situation encountered with the prior art.

### SUMMARY OF THE INVENTION

It is therefore an object of the present invention to improve the photocopying of nonplannar original images, such as books.

It is therefore another object of the present invention to combine the convenience and functionality of split scan scanning with the accuracy of book edge copying.

It is therefore further object of the present invention to accomplish the foregoing objectives with minimum modification.

According to an aspect of the present invention, the scanning system for scanning a document placed on a document platen and for projecting an image onto a photosensitive image medium to form a latent image of the document thereon includes a housing, a photosensitive scanner, and a scanning window. Meanwhile, the photosensitive scanner is adapted to move beneath the platen in a scan operation for projecting the image onto the photosensitive image medium to form the latent image. The scanning window is mounted on a ceiling of the housing and a fringe of the scanning window bordered with a frame, wherein a top surface of the scanning window is substantially equal to that of the one side of the frame in height.

Preferably, the photosensitive scanner is a charge-coupled device.

Preferably, the photosensitive scanner is a contact image sensor.

Preferably, the scanning system further includes an orientation slot disposed on one side of the frame.

Preferably, the scanning window has a downwardly sloping plane engaged with the orientation slot.

Preferably, the orientation slot includes an upper portion and a lower portion in which the upper portion has a downwardly sloping plane and the lower portion has a horizontal plane to form the orientation slot.

Preferably, the scanning window is an exposure glass.

According to another aspect of the present invention, the scanning system for scanning a document placed on a document platen and for projecting an image onto a photosensitive image medium to form a latent image of the document thereon includes a housing, an illumination lamp, and a scanning window. The illumination lamp is adapted to move beneath the platen in a scan operation for projecting the image onto the photosensitive image medium to form the latent image and two terminals of the illumination lamp having L-shaped structures. The scanning window is mounted on a ceiling of the housing and a fringe of the scanning window bordered with a frame, wherein a top surface of the scanning window is substantially equal to that of the one side of the frame in height.

Preferably, the illumination lamp is a fluorescent lamp which has two L-shaped structures.

Preferably, the illumination lamp is an array of light emitting diodes.

The present invention may best be understood through the following description with reference to the accompanying drawings, in which:

### BRIEF DESCRIPTION OF THE DRAWINGS

FIG. 1 is a stereographic diagram of a scanning system according to a preferred embodiment of the present invention;

FIG. 2-1 is a cross-sectional view showing of A-A line of FIG. 1;

FIG. 2-2 is a partial view of FIG. 1; and

FIG. 3 is a schematic diagram of a scanning system according to a preferred embodiment of the present invention.

### DETAILED DESCRIPTION OF THE PREFERRED EMBODIMENT

Although this invention is susceptible to embodiments of many different forms, a preferred embodiment will be described and illustrated in detail herein. The present disclosure exemplifies the principle of the invention and is not being considered a limitation to the broader aspects of the invention to the particular embodiment as described.

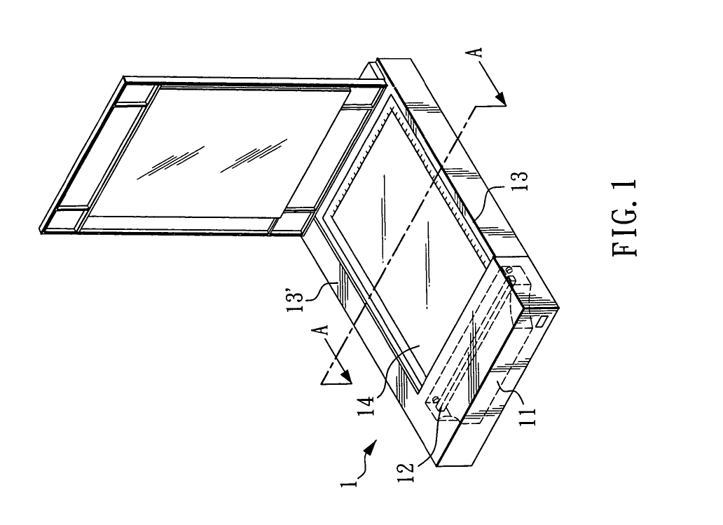

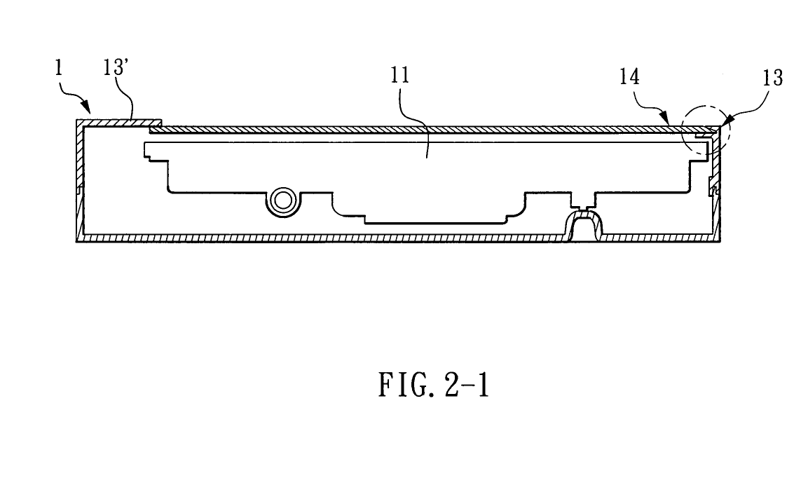

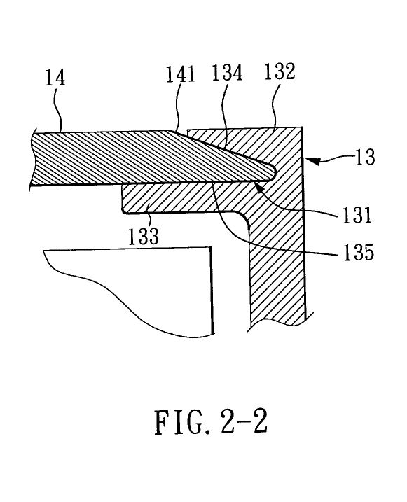

Please refer to FIGS. 1, 2-1, and 2-2. FIGS. 1, 2-1, and 2-2 are a stereographic diagram of a scanning system according to a preferred embodiment of the present invention, a cross-sectional view showing of A-A line of FIG. 1, and a partial view of FIG. 1 individually. As shown in FIGS. 1, 2-1, and 2-2, the scanning system for scanning a document placed on a document platen and for projecting an image onto a photosensitive image medium to form a latent image of the document thereon includes a housing 1, a photosensitive scanner 11, and a scanning window 14. Meanwhile, the photosensitive scanner 11 is adapted to move beneath the platen in a scan operation for projecting the image onto the photosensitive image medium to form the latent image. The scanning window 14 is mounted on a ceiling of the housing 1 and a fringe of the scanning window 14 bordered with frames 13, 13′, wherein a top surface of the scanning window 14 is substantially equal to or higher than that of the frame 13 in height. Therefore, in scanning operation the bound part of the book can be placed in the frame 13 position so that the entire surface of the page being copied is in intimate contact with the platen surface.

Meanwhile, the scanning system further includes an orientation slot 131 disposed on the frame 13. The scanning window 14 has a downwardly sloping plane 141 engaged with the orientation slot 131. The orientation slot 131 includes an upper portion 132 and a lower portion 133 in which the upper portion 132 has a downwardly sloping plane 134 and the lower portion 133 has a horizontal plane 135 to form the orientation slot 131.

Additionally, in the present invention the photosensitive scanner 11 utilizes an illumination lamp which has two ends with L-shaped structures. It can effectively shorten the width of the frame 13 so as to provide a larger scan zone. The scanning window 14 is an exposure glass. Certainly, the photosensitive scanner can be one of a charge-coupled device or a contact image sensor.

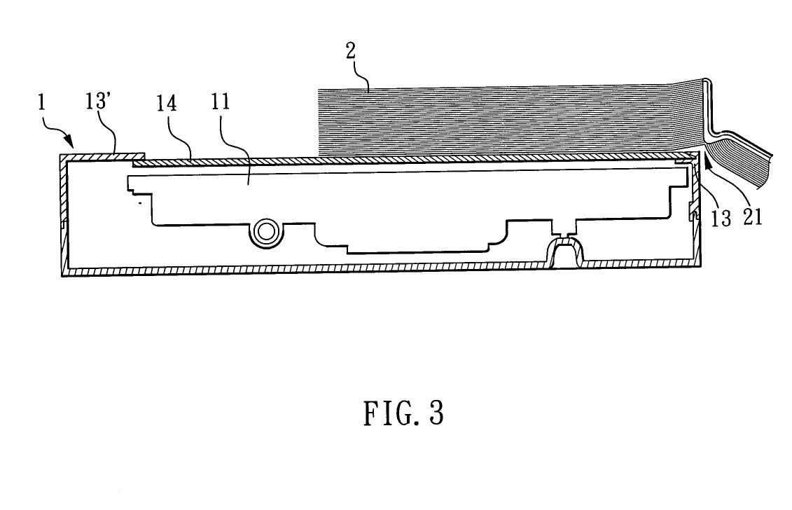

Please refer to FIG. 3. It is a schematic diagram of a scanning system according to a preferred embodiment of the present invention. According to the aforesaid, the bound part 21 of the book 2 can be placed in the frame 13 position so that the entire surface of the page being copied is in intimate contact with the platen surface.

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A scanning system for scanning a document placed on a document platen and for projecting an image onto a photosensitive image medium to form a latent image of said document thereon, said scanning system comprising:
a housing;
a photosensitive scanner adapted to move beneath said platen in a scan operation for projecting said image onto said photosensitive image medium to form said latent image; and
a scanning window mounted on a ceiling of said housing and a fringe of said scanning window bordered with a frame, wherein a top surface of said scanning window is substantially equal to that of said one side of said frame in height.

2. The scanning system of claim 1, wherein said photosensitive scanner is a charge-coupled device.

3. The scanning system of claim 1, wherein said photosensitive scanner is a contact image sensor.

4. The scanning system of claim 1 further comprising an orientation slot disposed on one side of said frame.

5. The scanning system of claim 1, wherein said scanning window has a downwardly sloping plane engaged with said orientation slot.

6. The scanning system of claim 4, wherein said orientation slot comprises an upper portion and a lower portion, and said upper portion has a downwardly sloping plane and said lower portion has a horizontal plane to form said orientation slot.

7. The scanning system of claim 1, wherein said scanning window is an exposure glass.

8. A scanning system for scanning a document placed on a document platen and for projecting an image onto a photosensitive image medium to form a latent image of said document thereon, said scanning system comprising:
a housing;
an illumination lamp adapted to move beneath said platen in a scan operation for projecting said image onto said photosensitive image medium to form said latent image and terminals of said illumination lamp having L-shaped structures; and
a scanning window mounted on a ceiling of said housing and a fringe of said scanning window bordered with a frame, wherein a top surface of said scanning window is substantially equal to that of said one side of said frame in height.

9. The scanning system of claim 8, wherein said illumination lamp is a fluorescent lamp which has two L-shaped structures.

10. The scanning system of claim 8, wherein said illumination lamp is an array of light emitting diodes.

11. A scanning system for scanning a document placed on a document platen and for projecting an image onto a photosensitive image medium to form a latent image of said document thereon, said scanning system comprising:
a housing;
a photosensitive scanner adapted to move beneath said platen in a scan operation for projecting said image onto said photosensitive image medium to form said latent image; and
a scanning window mounted on a ceiling of said housing and a fringe of said scanning window bordered with a frame, wherein a top surface of said scanning window is high than that of said one side of said frame in height.
